(19) United States
(12) Patent Application Publication
(10) Pub. No.: US 2019/0387578 A1
(43) Pub. Date: Dec. 19, 2019

(54) HANDLING MULTIPLE SR CONFIGURATIONS AND CORRESPONDING UL GRANTS

(71) Applicant: Intel Corporation, Santa Clara, CA (US)

(72) Inventors: Bharat Shrestha, Hillsboro, OR (US); Gang Xiong, Portland, OR (US); Yujian Zhang, Beijing (CN); Debdeep Chatterjee, San Jose, CA (US); Sergey Panteleev, Nizhny Novgorod (RU); Joonyoung Cho, Portland, OR (US); Youn Hyoung Heo, Seoul (KR)

(21) Appl. No.: 16/478,905

(22) PCT Filed: Jun. 15, 2018
(86) PCT No.: PCT/US2018/037859

§ 371 Date: Jul. 18, 2019

Related U.S. Application Data
(60) Provisional application No. 62/520,920, filed on Jun. 16, 2017.

(51) Int. Cl. H04W 88/02; H04W 72/14; H04W 72/12; H04L 5/00; H04W 76/27

(52) U.S. Cl. CPC H04W 88/023; H04W 72/14; H04L 5/0094; H04L 5/0082; H04W 76/27; H04W 72/1284

(57) ABSTRACT

A User Equipment (UE) and a Radio Access Network (RAN) node may be configured to use multiple Scheduling Request (SR) configurations. A SR configuration may indicate to radio resources to be used to communicate a SR to the RAN node. The RAN node may provide UE with information associating logical channels to SR configurations. When the UE has data to transmit to the RAN node, the UE may determine the logical channel corresponding to the data, determine the SR configuration corresponding to the logical channel, and communicate a SR to the RAN node in accordance with the SR configuration. Upon receiving the SR, the RAN node determine the SR configuration used to transmit the SR and in turn determine the logical channel for which the SR was transmitted. The RAN node may then transmit an Uplink (UL) grant for the logical channel to the UE.

### RELATED APPLICATIONS

The present application claims the benefit of U.S. Provisional Patent Application No. 62/520,920, which was filed on Jun. 16, 2017, the contents of which are hereby incorporated by reference as though fully set forth herein.

### BACKGROUND

Wireless telecommunication networks may include User Equipment (UE) (e.g., smartphones, tablet computers, laptop computers, etc.) Radio Access Networks (RANs) (that often include one or more base stations), and a core network. A UE may connect to the core network by communicating with a base station and registering with the core network. Communications between the UE and the base station may occur over one or more wireless channels established between the UE and the base station.

Communication channels between the UE and the base station may include Physical Uplink Control Channels (PUCCHs) and Physical Uplink Shared Channels (PUSCHs). In some scenarios, before a UE may communicate information to a base station, the UE may send a Scheduling Request (SR) message to the base station. The SR message may notify the base station that the UE has information to communicate to the base station. However, before the UE is able to do so, the base station may need to provide the UE with an Uplink (UL) grant. Providing the UE with a UL grant may indicate, to the UE, the portions of another channel (e.g., a PUSCH) that the UE may use to communicate the information to the UE.

### BRIEF DESCRIPTION OF THE DRAWINGS

Embodiments described herein will be readily understood by the following detailed description in conjunction with the accompanying drawings. To facilitate this description, like reference numerals may designate like structural elements. Embodiments are illustrated by way of example and not by way of limitation in the figures of the accompanying drawings.

FIG. 1 illustrates an architecture of a system of a network in accordance with some embodiments;

FIG. 2 is a flowchart diagram of an example process for communicating a Scheduling Request (SR) associated with a logical channel;

FIG. 3 is a block diagram of an example of information associating logical channels to SR configurations;

FIG. 4 is a flowchart diagram of an example process for mapping a logical channel to a SR configuration;

FIG. 5 is a sequence flow diagram of an example process for allocating Uplink (UL) grants based on an SR configuration associated with a logical channel;

FIG. 6 is a table of an example of information associating logical channels with SR configurations;

FIG. 7 is a block diagram of an example subframe of overlapping SR configurations;

FIG. 8 is a block diagram of an example Medium Access Control (MAC) Control Element (CE);

FIG. 9 is a flowchart diagram of an example process for transmitting a SR in accordance with a particular SR configuration;

FIG. 10 is a flowchart diagram of an example process for UL scheduling based on different SRs from different User Equipment (UEs);

FIG. 11 is a block diagram of example components of a device in accordance with some embodiments;

FIG. 12 is a block diagram of example interfaces of baseband circuitry in accordance with some embodiments;

FIG. 13 is a block diagram of an example control plane protocol stack in accordance with some embodiments;

FIG. 14 is a block diagram of an example user plane protocol stack in accordance with some embodiments; and

FIG. 15 is a block diagram of example components, according to some example embodiments, able to read instructions from a machine-readable or computer-readable medium (e.g., a non-transitory machine-readable storage medium) and perform any one or more of the methodologies discussed herein.

### DETAILED DESCRIPTION OF PREFERRED EMBODIMENTS

The following detailed description refers to the accompanying drawings. The same reference numbers in different drawings may identify the same or similar elements. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

User Equipment (UE) may establish a connection with a base station of a wireless telecommunication network to communicate with the network. In some scenarios, the UE may use a logical channel that corresponds to a physical channel shared by multiple UEs (e.g., a Physical Uplink Shared Channel (PUSCH)). As the channel may be shared by other devices, the UE may use a control channel (e.g., a Physical Uplink Control Channel (PUCCH) to send a Scheduling Request (SR) message to the base station, indicating that the UE has information to send to the base station. In response, the base station may allocate, or assign, a portion of the channel to the UE for sending the information and may notify the UE of the allocation by sending an Uplink (UL) grant message to the UE. The UE may send information to the base station in accordance with the UL grant. In this manner, multiple devices (e.g., UEs,) may use a shared channel to send information to a base station.

In some scenarios, the UE may be capable of using several logical channels to communicate information to the base station. Different logical channels may be used for distinct types of communications. Some logical channels may be used for high volume and/or high priority traffic, such as enhanced mobile broadband (eMBB), ultra-reliable low latency (URLLC) services, etc., while other logical channels may be used for lower volume and/or lower priority traffic. As such, to enable the UE to obtain UL grants for distinct logical channels, the base station may provide the UE with information about the capabilities of the logical channels available to the UE (e.g., channel priority, numerology, TTI, etc.) and information associating the logical channels to different SR configurations stored by the UE. A SR configuration, as described herein, may include parameters and/or other information describing radio resources (e.g., time, frequency, periodicity, transmission duration, maximum number of retransmission, etc.) for using a PUCCH to transmit a SR to the base station.

As such, when the UE is to communicate information to the base station, the UE may determine the logical channel that is to be used to communicate the information, determine the SR configuration associated with the logical channel, and transmit the SR to the base station in accordance with the SR configuration. Upon receiving the SR, the base station may determine the radio resource or SR configuration parameters used to communicate the SR, determine the SR configuration corresponding to the radio resources, determine the logical channel (or logical channel group) associated with that SR configuration, and generate and transmit a UL grant to the UE for that logical channel or logical channel group. Upon receiving the UL grant, the UE may then proceed to transmit information to the base station in accordance with the UL grant. As such, the techniques described herein may enable a Radio Access Network (RAN) to allocate channel resources (e.g., PUSCH resources) with greater efficiency by enabling UEs to communicate SR messages that indicate the logical channel or group of logical channel (e.g., high volume channels, mid volume channels, etc.) for which resources are being requested.

In some embodiments, logical channel groups may be used to associated logical channels with different SR configurations. In such a scenario, each logical channel may correspond to a certain channel group and determining which SR configuration to use in a particular scenario may depend on the logical channel group of the logical channel. Additionally, the base station may use dedicated Radio Resource Control (RRC) signaling, in-band signaling, and/or broadcast signaling to provide UEs with information associating logical channels to SR configuration, which may include periodically changing/updating which logical channels (or logical channel groups) are associated with which SR configurations. Additional techniques are discussed herein, such as the resolution of overlapping SR configurations, UE capability and preference signaling for logical channels, and more.

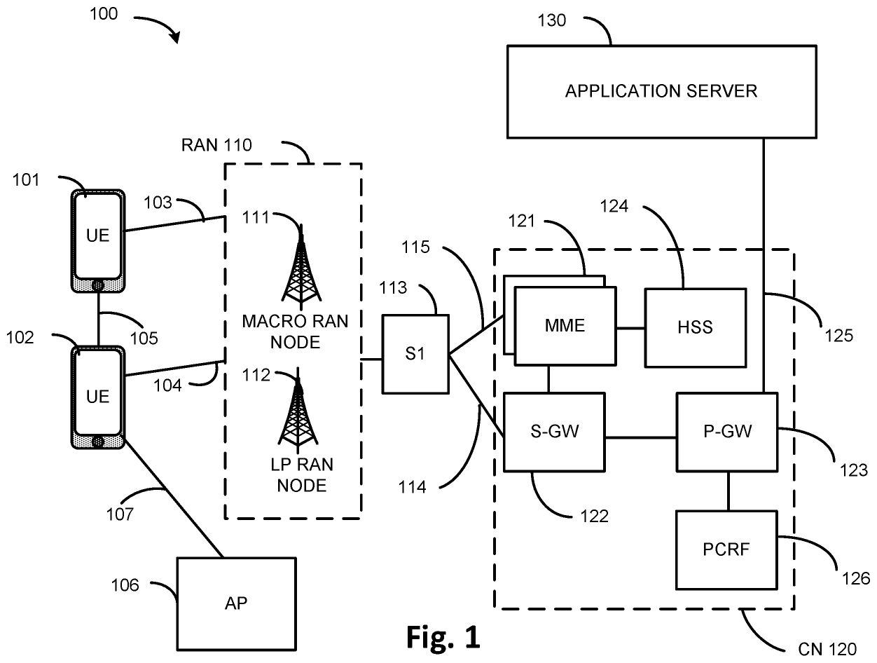

FIG. 1 illustrates an architecture of a system 100 of a network in accordance with some embodiments. The system 100 is shown to include UE 101 and a UE 102. The UEs 101 and 102 are illustrated as smartphones (e.g., handheld touchscreen mobile computing devices connectable to one or more cellular networks) but may also comprise any mobile or non-mobile computing device, such as Personal Data Assistants (PDAs), pagers, laptop computers, desktop computers, wireless handsets, or any computing device including a wireless communications interface.

In some embodiments, any of the UEs 101 and 102 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 101 and 102 may be configured to connect, e.g., communicatively couple, with a radio access network (RAN) 110—the RAN 110 may be, for example, an Evolved Universal Mobile Telecommunications System (UMTS) Terrestrial Radio Access Network (E-UTRAN), a NextGen RAN (NG RAN), or some other type of RAN. The UEs 101 and 102 utilize connections 103 and 104, respectively, each of which comprises a physical communications interface or layer (discussed in further detail below); in this example, the connections 103 and 104 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3rd Generation Partnership Program (3GPP) Long Term Evolution (LTE) protocol, a fifth generation (5G) protocol, a New Radio (NR) protocol, and the like.

In this embodiment, the UEs 101 and 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as a connection consistent with any IEEE 802.11 protocol, wherein the AP 106 would comprise a wireless fidelity (Wi-Fi®) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, eNBs, next Generation NodeBs (gNB), RAN nodes, and so forth, and can comprise ground stations (e.g., terrestrial access points) or satellite stations providing coverage within a geographic area (e.g., a cell). The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some embodiments, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management.

In accordance with some embodiments, the UEs 101 and 102 can be configured to communicate using Orthogonal Frequency-Division Multiplexing (OFDM) communication signals with each other or with any of the RAN nodes 111 and 112 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 111 and 112 to the UEs 101 and 102, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks. The physical downlink shared channel (PDSCH) may carry user data and higher-layer signaling to the UEs 101 and 102. The physical downlink control channel (PDCCH) may carry information about the transport format and resource allocations related to the PDSCH channel, among other things. It may also inform the UEs 101 and 102 about the transport format, resource allocation, and H-ARQ (Hybrid Automatic Repeat Request) information related to the uplink shared channel. Typically, downlink scheduling (assigning control and shared channel resource blocks to the UE 102 within a cell) may be performed at any of the RAN nodes 111 and 112 based on channel quality information fed back from any of the UEs 101 and 102. The downlink resource assignment information may be sent on the PDCCH used for (e.g., assigned to) each of the UEs 101 and 102.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as an enhanced resource element groups (EREGs). An ECCE may have other numbers of EREGs in some situations.

The RAN 110 is shown to be communicatively coupled to a core network (CN) 120—via an S1 interface 113. In embodiments, the CN 120 may be an evolved packet core (EPC) network, a NextGen Packet Core (NPC) network, or some other type of CN. In this embodiment, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this embodiment, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities may include lawful intercept, charging, and some policy enforcement.

The P-GW 123 may terminate an SGi interface toward a PDN. The P-GW 123 may route data packets between the EPC network 123 and external networks such as a network including the application server 130 (alternatively referred to as application function (AF)) via an Internet Protocol (IP) interface 125. Generally, the application server 130 may be an element offering applications that use IP bearer resources with the core network (e.g., UMTS Packet Services (PS) domain, LTE PS data services, etc.). In this embodiment, the P-GW 123 is shown to be communicatively coupled to an application server 130 via an IP communications interface 125. The application server 130 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Enforcement Function (PCRF) 126 is the policy and charging control element of the CN 120. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 126 may be communicatively coupled to the application server 130 via the P-GW 123. The application server 130 may signal the PCRF 126 to indicate a new service flow and select the appropriate Quality of Service (QoS) and charging parameters. The PCRF 126 may provision this rule into a Policy and Charging Enforcement Function (PCEF) (not shown) with the appropriate traffic flow template (TFT) and QoS class of identifier (QCI), which commences the QoS and charging as specified by the application server 130.

The quantity of devices and/or networks, illustrated in FIG. 1, is provided for explanatory purposes only. In practice, system 100 may include additional devices and/or networks; fewer devices and/or networks; different devices and/or networks; or differently arranged devices and/or networks than illustrated in FIG. 1. For example, while not shown, environment 100 may include devices that facilitate or enable communication between various components shown in environment 100, such as routers, modems, gateways, switches, hubs, etc. Alternatively, or additionally, one or more of the devices of system 100 may perform one or more functions described as being performed by another one or more of the devices of system 100. Additionally, the devices of system 100 may interconnect with each other and/or other devices via wired connections, wireless connections, or a combination of wired and wireless connections. In some embodiments, one or more devices of system 100 may be physically integrated in, and/or may be physically attached to, one or more other devices of system 100. Also, while “direct” connections may be shown between certain devices in FIG. 1, some of said devices may, in practice, communicate with each other via one or more additional devices and/or networks.

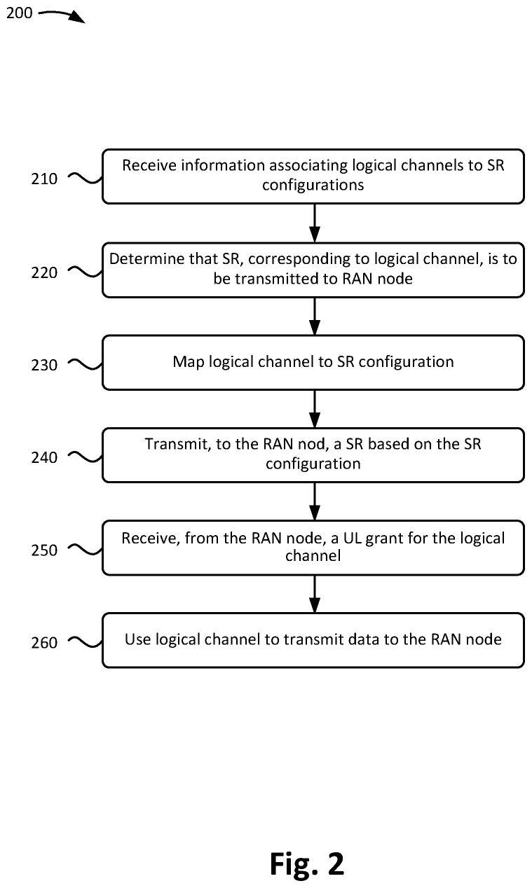

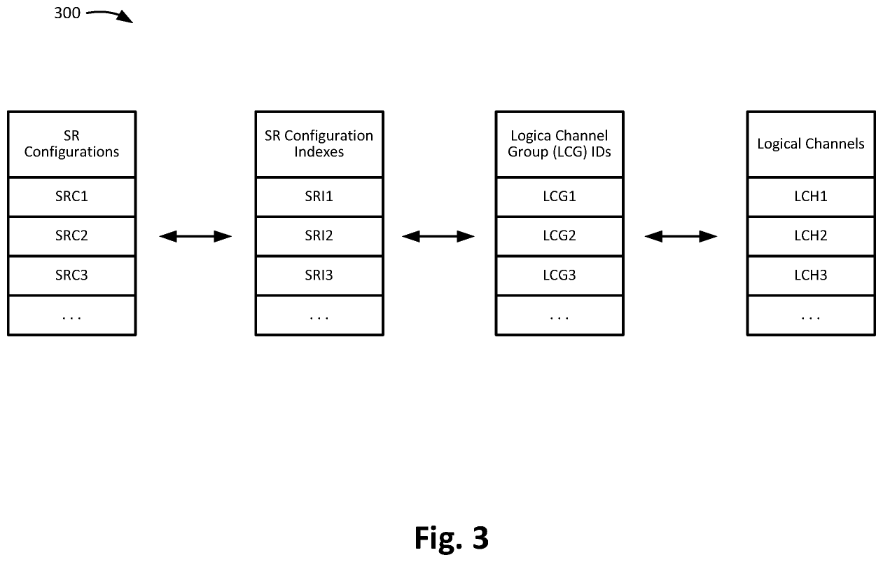

FIG. 2 is a flowchart diagram of an example process 200 for communicating a SR associated with a logical channel. Process 200 may be implemented by UE 101. FIG. 2 is described below with reference to FIGS. 3-5.

As shown, process 200 may include receiving information associating logical channels to SR configurations (block 210). For example, UE 101 may receive, from RAN node 111, system information, configuration information, and/or another type of information that indicates a logical association between one or more logical channels and one or more SR configurations. A SR configuration, as described herein, may include one or more values, parameters, or characteristics of a dedicated PUCCH resource for transmitting a SR to RAN node 111. In some embodiments, each SR configuration may include an SR configuration index that functions as an identifier for the SR configuration. Additionally, each logical channel may include a logical channel group identifier representing a logical channel group to which the logical channel corresponds. A logical channel group, as described herein, may include a category, type, or grouping of logical channels with similar characteristics, requirements, etc. (e.g., similar priority, bit rate, numerology, TTI, etc.).

FIG. 3 is a block diagram of an example 300 of information associating logical channels to SR configurations. As shown, example 300 may include SR configurations (e.g., SRC1, SRC2, etc.), SR configuration indexes (SRI1, SRI2, etc.), logical group identifiers (LCG1, LCG2, etc.), and logical channels (LCH1, LCH2, etc.). In some embodiments, the SR configurations depicted in FIG. 3 may include radio resources (including a periodicity, maximum number of retransmission, transmission duration, etc.) for transmitting an SR to RAN node 101. Similarly, the logical channels depicted in FIG. 3 may include characteristics of logical channels, such as a priority, prioritized bit rate, numerology, TTI, etc., of a logical channel.

As shown, each SR configuration may be associated with a SR configuration index that uniquely identifies the SR configuration, and each logical channel may be associated with a logical channel group identifier that indicates the logical channel group to which the logical channel corresponds. Additionally, by associating each logical channel group identifier with a SR configuration index, each logical channel may, in effect, be associated with a particular SR configuration index. In some embodiments, multiple logical channels may correspond to a single logical channel group, and each logical channel group (or multiple logical channel groups) may correspond to a single SR configuration.

Referring to FIG. 2, process 200 may also include determining that a SR, corresponding to a logical channel, is to be transmitted to RAN node 111 (block 220). For example, when UE 101 has data that is to be transmitted to RAN node 111, UE 101 may determine that a SR is to be transmitted to RAN node 111 so that, for example, UE 101 may obtain a UL grant for transmitting the data. In some embodiments, UE 101 may determine that the SR is to be transmitted in response to a trigger event (e.g., a buffering operation or another type of data processing operation) relating to a particular logical channel and/or logical channel group. In some embodiments, UE 101 may also, or alternatively, determine that the SR is to be transmitted based on another condition, trigger, or event.

Process 200 may also include mapping a logical channel to a SR configuration (block 230). For example, in response to determining that a SR is to be transmitted, UE 101 may determine a logical channel (or logical channel group) for transmitting the data. This may be configured by RAN node 111 based on one or more factors, such as characteristics or requirements (e.g., priority, data rate, Quality of Service (QoS), etc.) of the data to be transmitted being met or satisfied by the characteristics and/or capabilities of the logical channel since, in some embodiments, one logical channel may be more suitable than another to transit certain types of data. For example, a SR configuration indexes may be associated with one or more characteristics (e.g., a priority, prioritized bit rate, numerology, TTI, etc.) of a logical channel, and UE 101 may determine the SR configuration for transmitting the SR by determining the SR configuration index associated with the logical channel characteristics suitable for transmitting the data. Upon determining the SR configuration index, UE 101 may then identify the corresponding SR configuration that sets for the radio resources (e.g., periodicity, transmission duration, maximum retransmissions, etc.) for transmitting an SR that will indicate, to RAN node 111, the logical channel and/or logical channel group for which UE 101 is requesting UL resources.

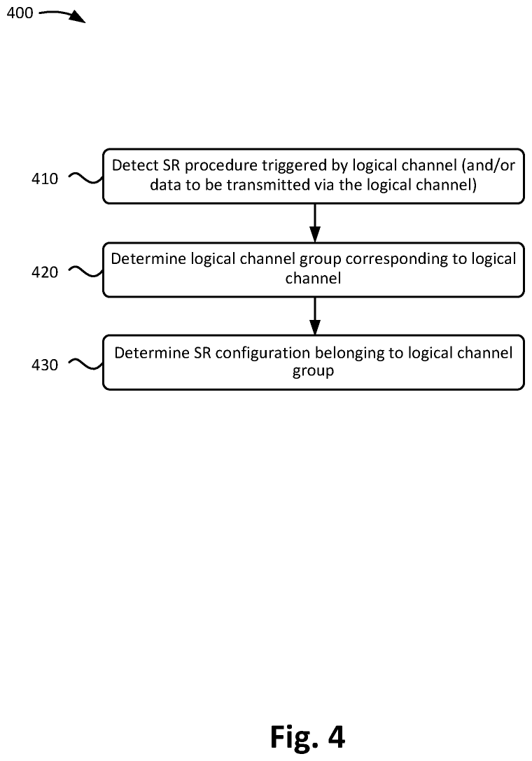

FIG. 4 is a flowchart diagram of an example process 400 for mapping a logical channel to a SR configuration. Process 200 may be implemented by UE 101.

As shown, process 400 may include detecting that a SR procedure has been triggered by a logical channel (and/or data to be transmitted via the logical channel) (block 410). For example, when UE 101 processes data that is to be transmitted to RAN node 111 via a PUSCH, UE 101 may determine that a SR is to be communicated to RAN node 111 for a UL grant regarding the PUSCH. The triggering event may include one or more of a variety of conditions, scenarios, and/or events, such as executing in an operation or a process that is part of, leads to, etc., the transmission of data to RAN node 111.

Process 400 may include determining a logical channel group corresponding to the logical channel (block 420). For example, UE 101 may determine a logical channel group identifier associated with the logical channel to be used to transmit the data to RAN node 111. Additionally, or alternatively, UE 101 may determine a logical channel group identifier associated with characteristics (e.g., a priority, prioritized bit rate, numerology, TTI, etc.) associated with the logical channel to be used to transmit the data to RAN node 111. Additionally, or alternatively, UE 101 may determine a logical channel group identifier associated with the transmission requirements and/or characteristics (e.g., priority, data rate, Quality of Service (QoS), etc.) of the data to be transmitted to RAN node 111.

Process 400 may include determining a SR configuration that belongs to the logical channel group (block 430). For example, UE 101 may map the logical channel group identifier to a SR configuration index based on configuration information previously received from RAN node 101. The SR configuration index may be associated with a particular SR configuration describing dedicated PUCCH resources for transmitting the SR. As such, UE 101 may map a logical channel to a SR configuration based on a logical channel group to which the logical channel corresponds.

Referring to FIG. 2, process 200 may also include transmitting, to RAN node 111, a SR based on an SR configuration (block 240). As mentioned above, the SR configuration may include parameters, instructions, and/or other types of information for using dedicated PUCCH resources for transmitting a SR. As such, upon determining an appropriate SR configuration for particular logical channel and/or logical channel group, UE 101 may transmit the SR, to RAN node 111, using the dedicated radio resources set forth by the SR configuration.

Process 200 may include receiving, from RAN node 111, a UL grant for the logical channel. For example, UE 101 may receive, from RAN node 111, a UL grant for the logical channel to be used to transmit the data. As described herein, since UE 101 may include multiple SR configurations, each of which may set forth different PUCCH resources for transmitting SRs to RAN node 111, and since the SR configuration used in a particular instance may be based on the characteristics of the data to be transferred (e.g., via the PUSCH), the logical channel to be used to transmit the data, and/or the logical channel group to which the logical channel pertains, RAN node 111 may determine (or infer) the logical channel (or logical channel group) to which an SR pertains and, therefore, generate a UL grant for that logical channel or logical channel group. As such, UE 101 may, in effect, inform RAN node 111 about which logical channel UE 101 intends to use to transmit data by the radio resources (e.g., time, frequency, periodicity, transmission duration, maximum number of retransmission, etc.) used to transmit the SR.

Process 200 may include using the logical channel to transmit data to RAN node 111. The UL grant from RAN node 111 may include an allocation of radio resources (e.g., PUSCH resources) for transmitting data to RAN node. As such, UE 101 may, in accordance with the UL grant from RAN node 111, use the logical channel to transmit data to RAN node 111.

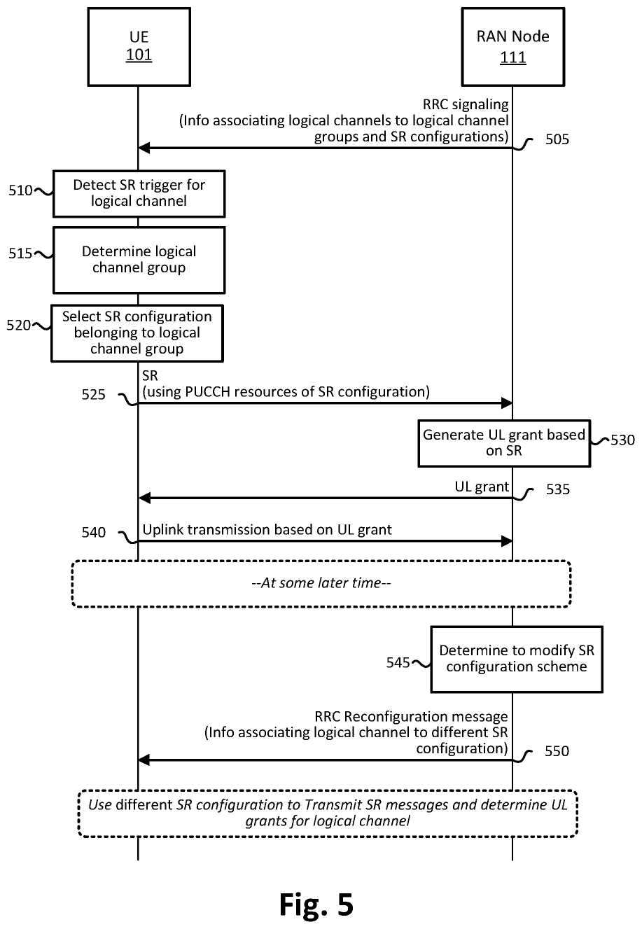

FIG. 5 is a sequence flow diagram of an example process for allocating UL grants based on an SR configuration associated with a logical channel. As shown, the example of FIG. 5 may include UE 101 and RAN node 111. The example process of FIG. 5 is provided as a non-limiting example. In practice, the example of FIG. 5 may include fewer, additional, and/or alternative, operations or functions. Additionally, one or more of the operations or functions of FIG. 5 may be performed by fewer, additional, and/or alternative devices, which may include one or more of the devices described above with reference to FIG. 1.

As shown, RAN node 111 may communicate, to UE 101, information associating logical channels with logical channel groups and SR configurations (at 505). In some embodiments, RAN node 111 may communicate the information using dedicated RRC signaling (e.g., RRC configuration messages, RRC reconfiguration messages, etc.). In some embodiments, RAN node 111 may transmit the information to UE 110 via in-band signaling, broadcast signaling, or another type of signaling technique. The information may indicate logical channels that are associated with logical channel group identifiers and SR configuration indexes. The SR configuration indexes may correspond to SR configuration information already stored by UE 101, so that the information provided to UE 101 may enable UE 101 to map logical channels (and/or logical channel groups) to appropriate SR configurations.

At some point, UE 101 may detect a SR trigger for one of the logical channels available to UE 101 and RAN node 111 (at 510). The SR trigger may indicate to UE 101 that UE 101 has data to be transmitted to RAN node 111. In some embodiments, the SR may be triggered by the logical channel (e.g., a process corresponding to using, or an anticipated use of, the logical channel) and/or by a logical channel group (e.g., a process corresponding to using, or an anticipated use of, a logical channel corresponding to a particular logical channel group).

UE 101 may determine a logical channel group associated with the SR trigger (at 515). In some embodiments, the SR trigger event may produce a logical channel group identifier indicating, to UE 101, the types or grouping of logical channels that are suitable or preferred for transmitting the data to RAN node 111. In some embodiments, UE 101 may also, or alternatively, identify the transmission requirements, preferences, and other characteristics (e.g., a priority, QoS, data rate, time sensitivity, etc.) of the data to be transmitted and determine a logical channel group associated with channel transmission capabilities that meet or exceed the transmission requirements, preferences, etc., of the data.

As shown, UE 101 may select a SR configuration that belongs to the logical channel group (at 520). As mentioned above, RAN node 111 may have provided UE 101 with configuration information associating logical channels with logical channel groups and SR configurations. As such, after UE 101 identifies a logical channel group for transmitting the data, UE 101 may map the logical channel group to a SR configuration based on the configuration information previously received from RAN node 111.

UE 101 may transmit, to RAN node 111, an SR based on the SR configuration (at 525). As mentioned above, the SR configuration may include signaling resources (e.g., PUCCH resources) for communicating a SR to RAN node 111. As such, after UE 101 has selected a SR configuration, UE 101 may use the SR configuration to transmit a SR to RAN node 111. In response, RAN node 111 may generate a UL grant based on the SR (at 530). RAN node 111 may provide the UL grant corresponding to the numerology and TTI information that RAN node 111 provided to UE 101 for the logical channel or logical channel group.

In response to a SR from UE 101, RAN node 111 may determine which SR configuration was used to communicate the SR based on the radio resources (e.g., PUCCH resources) used to communicate the SR. RAN node 111 may map the SR configuration to a logical channel group (and/or logical channel), and generate a UL grant consistent with the transmission characteristics, capabilities, etc. (e.g., the PUSCH resources) of the logical channel group (and/or logical channel). In this manner, UE 101 may be enabled to transmit an SR that indicates the characteristics and/or properties of the logical channel for which resources are being requested and RAN node 111 may be enabled to use SRs to provide appropriate UL grants. RAN node 111 transmit the UL grant to UE 101 (at 535) and in response UE 101 may transmit data to RAN node 111 according to the UL grant (at 540).

At some point, RAN node 111 may determine to change, update, etc., the SR configuration scheme being implemented by the network (at 545). Modifying the SR configuration scheme may include changing one or more SR configurations (e.g., the PUCCH resources associated with one or more SR configurations), changing which logical channels (and/or logical channel groups) are associated with one or more SR configurations, etc. RAN node 11 may determine modify the SR configuration scheme based on, and/or the result of, one or more of a variety of conditions, factors, and scenarios, including the preferences and/or capabilities of UEs 101, a change in the preferences and/or capabilities of RAN node 111, network congestion or other conditions, logical channel transmission trends, instructions from a network administrator, etc.

In response to determining to modify the SR configuration scheme, RAN node 111 may generate and transmit reconfiguration information to UEs 101 (at 550). In some embodiments, RAN node 111 may do so using dedicated RRC signaling (e.g., RRC reconfiguration messages. Additionally, or alternatively, RAN node 111 may use another transmission technique, such as an in—and signaling, broadcast signaling, etc. UE 101 may receive and store the reconfiguration information, so that UE 101 may transmit subsequent SRs in a manner consistent with the updated SR configuration scheme.

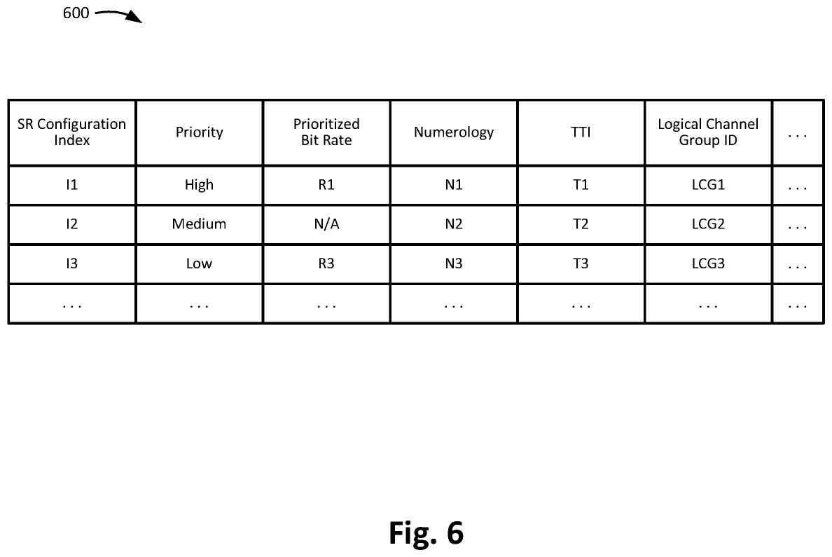

FIG. 6 is a table of an example 600 of information associating logical channels with SR configurations. As shown, example 600 may include a SR configuration index (I1, I2, etc.), a priority (e.g., high, medium, low, etc.), a prioritized bit rate (e.g., R1, R2, etc.), a numerology (N1, N2, etc.), a Transition Time Interval (TTI) (e.g., T1, T2, etc.), and a logical channel group identifier. Example 600 is a non-limiting example of information associating logical channels with SR configurations. Example 600 may include fewer, additional, alternative, information. For example, example 600 may include a type of Buffer Status Reporting (BSR) triggered by the corresponding SR. Additionally, in practice, the information represented in example 600 may be arranged in a variety of different data structures beyond a table of information.

The SR configuration index (or SR Configuration Mapping Index) may identify a SR configuration. While not shown in FIG. 6, as mentioned above, a SR configuration, as described herein, may include one or more characteristics (e.g., a periodicity, subcarrier spacing, transmission duration, etc.) of a dedicated PUCCH resource for transmitting a SR to RAN node 111. Thus, the SR configuration index of example 600 may be used by UE 101 and RAN node 111 to map, identify, determine, etc., a SR configuration associated with a logical channel and/or logical channel group defined by, or otherwise consistent with, one or more of the corresponding channel attributes of example 600 (e.g., priority, prioritized bit rate, numerology, and/or logical channel group identifier). In some embodiments, one or more of the characteristics of the PUCCH resource for SRs may be implied from one or more of the channel attributes (e.g., numerology and/or TTI) of example 600.

The priority may indicate a relative priority of a logical channel (and/or a relative priority of data to be transmitted via the logical channel). Prioritized bit rate may include a data rate that is to be allocated to the logical channel (e.g., before allocating transmission resource to one or more lower-priority logical channels). Numerology may indicate the numerology of the logical (e.g., 15 kilohertz (KHz), 30 KHz, 60 KHz, etc.), and TTI may indicate a duration for using the logical channel to transmit data. In some embodiments, the numerology/TTI may indicate Sub-Carrier Spacing (SCS) (i.e., frequency spacing between adjacent subcarriers) and PUSCH transmission duration. Logical channel group identifier may identify a logical channel group to which one or more logical channels may pertain. In some embodiments, logical channels with similar characteristics (e.g. priority, prioritized bit rate, numerology, etc.) may be allocated to the same logical channel group.

In some embodiments, the channel attributes (e.g., priority, prioritized bit rate, numerology, TTI, etc.) may be characteristics of a logical channel group (as opposed to, for example, a particular logical channel). In such embodiments, the logical channel group identifier may uniquely identify the corresponding set of channel attributes. In other embodiments, the logical channel group identifier may be used to reference to another data structure defining the characteristics (e.g., priority, prioritized bit rate, numerology, TTI, etc.) of each logical channel group.

Example 600 may represent an example of configuration information that RAN node 111 may transmit to UE 101. As mentioned above, in some embodiments, RAN node 111 may use dedicated RRC signaling to provide the information, though RAN node 111 may also use in-band signaling and broadcast signaling as well. The configuration of example 600, and other information such as SR configurations) may be provided in one or more Information Elements (IEs).

An example of such an IE may include SchedulingRequestConfig, which may parameters used to define SR configurations and map the SR configuration to logical channels and/or logical channel groups. As shown in Table 1 below, SchedulingRequestConfig may include sr-ConfigMappingIndex, which may be used to determine a periodicity of a corresponding SR configuration, in addition to information such as priority or numerology/TTI length. For an example, the FIG. 2 below shows that for each PUCCH resource index, sr-ConfigMappingIndex is provided which identifies SR parameters such as the sr-configIndex (SR period) and other corresponding information (e.g., priority, numerology/TTI length) using a pre-defined mapping table an example of which is shown in table 1. Note that sr-ConfigMappingIndex may also indicate only sr-configIndex (SR period) and logical channel group.

TABLE 1
SchedulingRequestConfig Information Element

-- ASN1START
SchedulingRequestConfigList::= SEQUENCE (SIZE (1..maxSR-config))
OF SchedulingRequestConfig
SchedulingRequestConfig::= CHOICE {

| | |
|---|---|
| release | NULL, |
| setup | SEQUENCE |

| | |
|---|---|
| sr-PUCCH-ResourceIndex | INTEGER (0..2047), |
| sr-ConfigMappingIndex | INTEGER (0.. maxsr-Index), |
| dsr-TransMax | ENUMERATED { |

n4, n8, n16, n32, n64,
spare3, spare2, spare1}

}

}

| | |
|---|---|
| maxSR-config | INTEGER (8) |

In another example (shown in Table 2 below) instead of providing an index value (e.g., sr-ConfigMappingIndex), SchedulingRequestConfig IE may include one or more parameters (e.g., priority, numerology, TTI, etc.) for transmitting a corresponding SR.

TABLE 2
SchedulingRequestConfig Information Element

-- ASN1START
SchedulingRequestConfigList::= SEQUENCE (SIZE (1..maxSR-config))
OF SchedulingRequestConfig
SchedulingRequestConfig::= CHOICE {

| | |
|---|---|
| release | NULL, |
| setup | SEQUENCE { |

| | |
|---|---|
| sr-PUCCH-ResourceIndex | INTEGER (0..2047), |
| sr-ConfigMappingIndex | INTEGER (0..maxsr-Index), |
| dsr-TransMax | ENUMERATED { |

n4, n8, n16, n32, n64,
spare3, spare2, spare1}

| sr-PriorityIndex | INTEGER (1..8), |
|---|---|
| sr-Numerology | ENUMERATED {7dot5KHz, |
| | 15KHz, 30KHz, 60KHz} |
| sr-TTI | ENUMERATED {0dot25ms, |

0dot5ms, 1ms, 2ms}

}

}

| | |
|---|---|
| maxSR-config | INTEGER (8) |

In another example (as shown in Table 3 below) the SchedulingRequestConfig IE may provide both an index value (e.g., sr-ConfigMappingIndex) and parameters for transmitting a corresponding SR.

TABLE 3
SchedulingRequestConfig Information Element

-- ASN1START
SchedulingRequestConfigList::= SEQUENCE (SIZE (1..maxSR-config))
OF SchedulingRequestConfig
SchedulingRequestConfig::= CHOICE {

| | |
|---|---|
| release | NULL, |
| setup | SEQUENCE { |

| | |
|---|---|
| sr-PUCCH-ResourceIndex | INTEGER (0..2047), |
| sr-ConfigMappingIndex | INTEGER (0..maxsr-Index), |
| dsr-TransMax | ENUMERATED { |

n4, n8, n16, n32, n64,
spare3, spare2, spare1}

}

}

| | |
|---|---|
| SR-ConfigMapping::= | SEQUENCE { |

| sr-PriorityIndex | INTEGER (1..8), |
|---|---|
| sr-Numerology | ENUMERATED {7dot5KHz, |
| | 15KHz, 30KHz, 60KHz} |
| dsr-TransMax | ENUMERATED {0dot25ms, |

0dot5ms, 1ms, 2ms}

}

| | |
|---|---|
| maxSR-config | INTEGER (8) |

The IEs (and parameters therein) discussed above with reference to Tables 1-3 are provided as non-limiting examples. In practice, the techniques described herein may include the use of fewer, additional, and/or alternative IEs. Similarly, the parameters provided in each IE, and the manner in which the IEs may reference one another (e.g., via identifiers, indexes, etc.) may vary without departing from the scope of the techniques described herein.

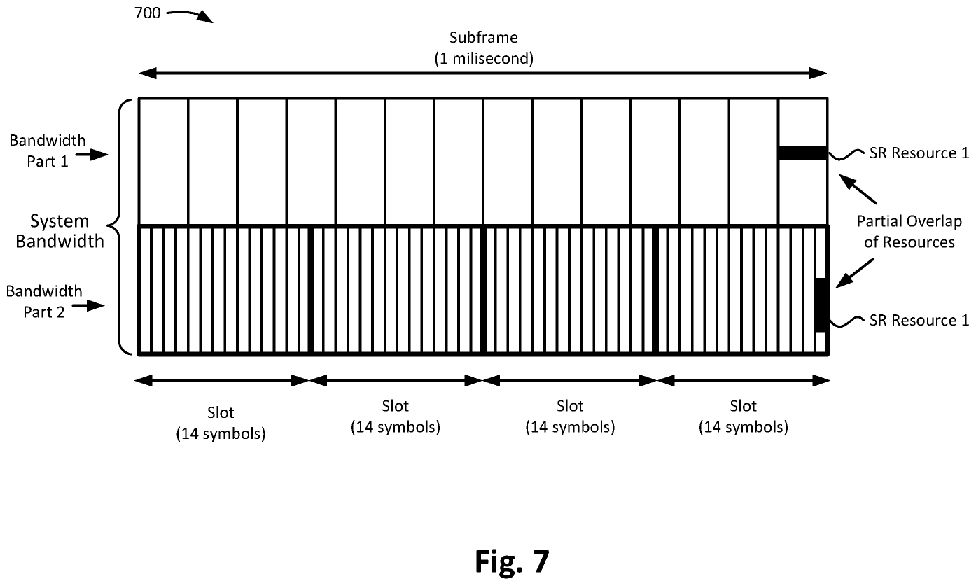

FIG. 7 is a block diagram of an example subframe 700 of overlapping SR configurations. As shown, example 700 may include a system bandwidth that includes bandwidth part 1 and bandwidth part 2, each with a distinct numerology (e.g., different arrangements of slots and symbols within a 1 millisecond subframe). Also shown are the resources allocated to different SR configuration, SR configuration 1 and SR configuration 2, which partially overlap with one another. As such, when UE 101 is configured with multiple SR resources, it is possible that resources for different SR configurations may overlap in time, time and frequency, or time and code.

In some embodiments, the manner (e.g., rules) in which UE 101 determines which SRs to transmit and which SRs to drop, in an overlap scenario, may vary from one UE 101 to another UE 101. In some embodiments, when UE 101 is to transmit multiple SRs, UE 101 may be configured to determine whether the SRs would overlap with respect to time, and if so, only transmit one SR while dropping the other SRs. In other words, UE 101 may not be configured to use multiple PUCCHs for a given time with same or different numerologies. Note that the dropping rule or prioritization rule may be predefined in the specification or configured by higher layers via NR minimum system information (MSI), NR remaining minimum system information (RMSI), NR system information block (SIB), or RRC signaling. In such an embodiment, UE 101 may determine which SR to transmit and which SR to drop based on one or more factors, which may a comparison of one or more characteristics (e.g., priority, TTI length, numerology, etc.) of the SRs and/or corresponding logical channels. Additionally, or alternatively, when UE 101 does not support frequency division multiplexing (FDM) of different numerologies for a given time instance, UE 101 may transmit an SR in accordance with a dropping rule or priority rule, which may include instructions for comparing, analyzing, evaluating, etc., one or more of the characteristics of the SRS and/or corresponding logical channels.

In some embodiments, UE 101 may be configured to transmit the SR triggered by the logical channel (LCH) corresponding to higher priority or shorter TTI or shorter time slot but delays the SR triggered by the LCH corresponding to lower priority or longer TTI or longer time slot to next SR opportunity. In some embodiments, in an overlapping scenario, UE 101 may be configured the SR corresponding to a shortest time slot or TTI length. UE 101 may also, or alternatively, use a different PUCCH formats, or different sequences, to transmit the SR, to indicate, to RAN node 111, that UE 101 is transmitting overlapping SRs.

Further, when one or more of the SR resources overlap in as time-domain with a Hybrid Automatic Repeat Request Acknowledgement (HARQ-ACK) resource (with HARQ-ACK feedback due from UE 101) UE 101 may determine whether to transmit the HARQ-ACK feedback or the overlapping SR based on whether the HARQ-ACK feedback corresponds to a previous SR with a higher priority than the overlapping SR.

By contrast, in some embodiments, UE 101 may be configured to transmit all of the overlapping SRs, regardless of whether the overlapping involves time, frequency, code, etc. Following such an option, in the case of one or more of the SR resources overlapping in the time-domain with a HARQ-ACK resource, regarding a HARQ-ACK feedback due from UE 101, UE 101 may transmit the HARQ-ACK feedback on the SR resource corresponding to the same numerology as the HARQ-ACK resource in case of positive SR.

In some embodiments, when UE 101 is allowed/configured to transmit more than one SR at the same time, a power sharing mechanism based on services priority may be implemented. For example, UE 101 may operate according to a rule, or another type of logical instruction, to allocate power in the descending priority order (e.g., first allocate available power to the operation and/or transmission with the highest priority, determine whether there is enough power headroom to perform the operation and/or transmission with the next highest priority, and so on. When there is no longer enough power headroom to perform a subsequent operation and/or transmission, UE 101 may be configured to drop the operation and/or transmission.

In some embodiments, within a same time slot of a reference numerology (e.g., 15 KHz) or in the adjacent time slots, there may be multiple SR resources that are not at the same time instance but are within a very short time duration, which may be based on a SR processing time or a time slot duration of a reference numerology. In such a scenario, UE 101 may be configured to transmit multiple SRs before receiving an UL grant or transmitting a BSR. In some embodiments, UE 101 may be configured to transmit all possible SRs before receiving an UL grant or before transmitting a BSR. Additionally, in such a scenario, SRs may correspond to different numerology/TTI lengths, and RAN node 111 may provide UL grants for both numerologies/TTI lengths requested.

In some embodiments, in an overlapping SR scenario, UE 101 may be configured to determine and transmit the SR corresponding to the highest priority, shorter TTI, shorter slot length, etc., and drop all other SRs. In some embodiments, in an overlapping SR scenario, UE 101 may be configured to determine (beforehand) or detect (in real-time) SRs scenarios in which multiple SRs are triggered with resources within a short time duration. In such embodiments, UE 101 may be configured to choose to transmit only the SR triggered by the LCH corresponding to higher priority, shorter TTI, or shorter time slot, and not to transmit (or delay to next opportunity) the SR triggered by the LCH corresponding to lower priority, longer TTI, or longer time slot (so long as both SR resources occur within a certain time period T). The time period T may be defined, in terms of TTI or time slot, of a reference numerology or SR processing time.

In some embodiments, RAN node 111 may receive multiple SRs from UE 101 before RAN node 111 responds to any of the SRs with a UL grant to UE 101. In such scenarios, RAN node 111 may be configured/capable of operating in one or more ways. For example, RAN node 111 may provide UL grants for all SRs at different time and frequency. Additionally, if/when the time instances of the UL grants overlap, RAN node 111 may be configured to provide the overlapping UL grants in different frequencies but still at the same time instance. In some embodiments, to distinguish the UL grant of the associated SR, RAN node 111 may be configured use a SR configuration mapping index in the Downlink Control Information (DCI) of the PDCCH scheduling the UL grant. Additionally, to notify UE 101 that a second UL grant may follow after a first UL grant, an indication bit may be used in the DCI of the PDCCH scheduling the UL grant.

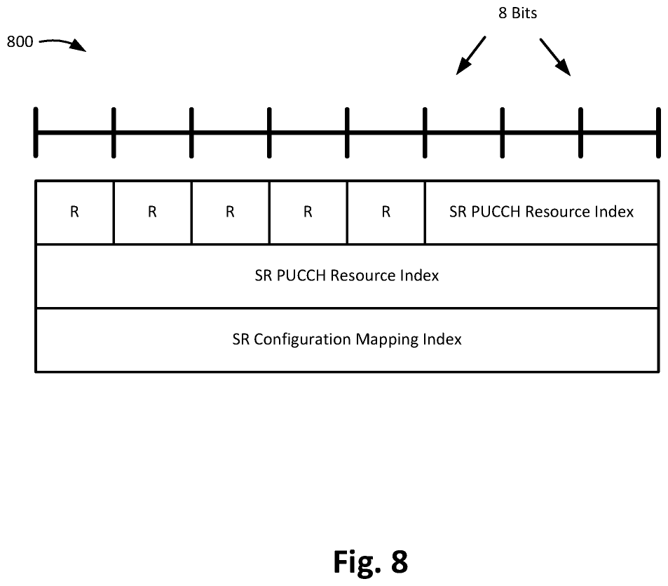

FIG. 8 is a block diagram of an example MAC Control Element (CE) 800 that may indicate an association between one or more logical channels and one or more SR configurations. As shown, MAC CE 800 may include information associating a logical channel (and/or PUCCH resource) with a SR configuration. In the example of FIG. 8, this may be accomplished by providing a sr-PUCCH ResourceIndex parameter, in combination with a sr-PUCCH ResourceIndex parameter. In some scenarios, the sr-PUCCH ResourceIndex parameter may indicate a particular PUCCH resource, and the sr-ConfigMappingIndex parameter may indicate a corresponding SR configuration, which may include a periodicity, a maximum transmission duration etc., for a corresponding SR. In some embodiments, downlink control information (DCI) in a PDCCH may be used to change, update, reconfigure, etc., one or more SR configurations and/or the logical channels (and/or logical channel groups) to which a SR configuration may correspond. In some embodiments, one or more SR configurations may be activated (and/or deactivated) by signaling the SR configuration mapping index in the MAC CE (or DCI) of a Physical Downlink Control Channel (PDCCH).

In some embodiments, RAN node 111 may also, or alternatively, use broadcast signaling to provide (and/or configure) UE 101 with information associating logical channels (and/or corresponding parameters, such as priority, periodicity, etc.) to SR configurations. In some embodiments, RAN node 111 my use system information (e.g., System Information Blocks (SIBs)) to convey which SR configuration is to be used in a particular scenario. An example of a SIB that RAN node 111 may use and transmit to UE 101, to indicate logical channels associated with which SR configurations is provide below in Table 4.

TABLE 4
RadioResourceConfigCommon System Information Block (SIB)

| | |
|---|---|
| RadioResourceConfigCommonSIB ::= | SEQUENCE { |

| | |
|---|---|
| rach-ConfigCommon | RACH-ConfigCommon, |
| bcch-Config | BCCH-Config, |
| pcch-Config | PCCH-Config, |
| prach-Config | PRACH-ConfigSIB, |
| pdsch-ConfigCommon | PDSCH-ConfigCommon, |
| pusch-ConfigCommon | PUSCH-ConfigCommon, |
| pucch-ConfigCommon | PUCCH-ConfigCommon, |

| | |
|---|---|
| soundingRS-UL-ConfigCommon | SoundingRS-UL-ConfigCommon, |
| uplinkPowerControlCommon | UplinkPowerControlCommon, |
| ul-CyclicPrefixLength | UL-CyclicPrefixLength, |

| ..., | |
|---|---|
| [[ | SchedulingRequestConfigList::= SEQUENCE (SIZE (1..maxSR-config)) OF |

SchedulingRequestConfig

| | |
|---|---|
| SchedulingRequestConfig::= | SEQUENCE { |

| | |
|---|---|
| sr-PUCCH-ResourceIndex | INTEGER |

(0..2047),

| | |
|---|---|
| sr-ConfigMappingIndex | INTEGER (0.. maxsr-Index) |

}

]],

}

In some embodiments, UE 101 may transmit, to RAN node 111, an indication of whether UE 101 supports multiple SR configurations and/or the number of SR configurations supported by UE 101. For example, if a UE supports only two SR configurations, then the RAN node 111 may map one SR configuration to a high priority logical channel and the other to a lower priority logical channel. An example of a message that UE may use to communicate capabilities is provided below in Table 5.

TABLE 5
UECapabilityInformation message

-- ASN1START

| UECapabilityInformation ::= | | SEQUENCE { |
|---|---|---|
| | rrc-TransactionIdentifier | RRC-TransactionIdentifier, |

| | |
|---|---|
| criticalExtensions | CHOICE { |

| | |
|---|---|
| c1 | CHOICE{ |

| | |
|---|---|
| ueCapabilityInformation | UECapabilityInformation-IEs, |
| ueSupportedSRConfig | INTEGER (1.. maxSR-config), |

spare6 NULL, spare5 NULL, spare4 NULL,
spare3 NULL, spare2 NULL, spare1 NULL

| }, | |
|---|---|
| criticalExtensionsFuture | SEQUENCE { } |

}

}
-- ASN1STOP

In some embodiments, UE 101 may transmit, to RAN node 111, an indication of a preference for UE 101 to use one or more logical channels and/or SR configurations (e.g., (numerology/TTI length) based on services supported by UE 101. An example of a message that UE, in RRC connected mode, may use to communicate such preferences is provided below in Table 6.

TABLE 6
UEAssistanceInformation message

-- ASN1START

| UEAssistanceInformation::= | | SEQUENCE { |
|---|---|---|
| | criticalExtensions | CHOICE { |

| | |
|---|---|
| c1 | CHOICE { |

| | |
|---|---|
| ueAssistanceInformation | UEAssistanceInformation -IEs, |

spare3 NULL, spare2 NULL, spare1 NULL

| }, | |
|---|---|
| criticalExtensionsFuture | SEQUENCE { } |

}

}

| UEAssistanceInformation-IEs ::= | | SEQUENCE { | |
|---|---|---|---|
| | powerPrefIndication | ENUMERATED {normal, lowPowerConsumption} | |
| | OPTIONAL, | srConfigPrefIndication | SRConfigPrefList, |

| | | |
|---|---|---|
| lateNonCriticalExtension | OCTET STRING | OPTIONAL, |

| | |
|---|---|
| nonCriticalExtension | SEQUENCE { } OPTIONAL |

}

| | |
|---|---|
| SRConfigPrefList::= | SEQUENCE (SIZE (1..maxSR-config)) OF sr-ConfigMappingIndex |

| | |
|---|---|
| sr-ConfigMappingIndex | INTEGER (0.. maxsr-Index) |

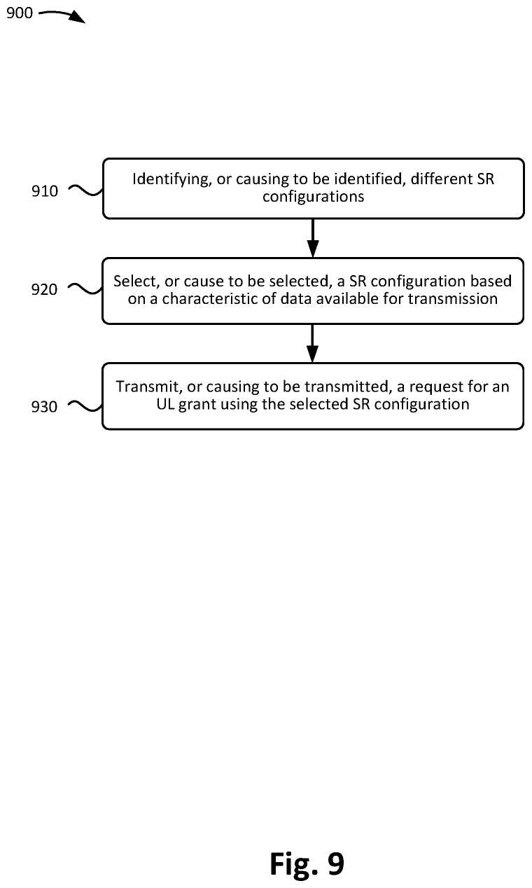

FIG. 9 is a flowchart diagram of an example process 900 for transmitting a SR in accordance with a particular SR configuration. Process 900 may be performed by UE 101. As shown, process 900 may UE 101 include identifying, or causing to be identified, different SR configurations (block 910). Additionally, process 900 may include UE 101 selecting, or causing to be selected, a SR configuration based on a characteristic of data available for transmission (block 920). Process 900 may also include UE 101 transmit, or causing to be transmitted, a request for an UL grant using the selected SR configuration (block 930).

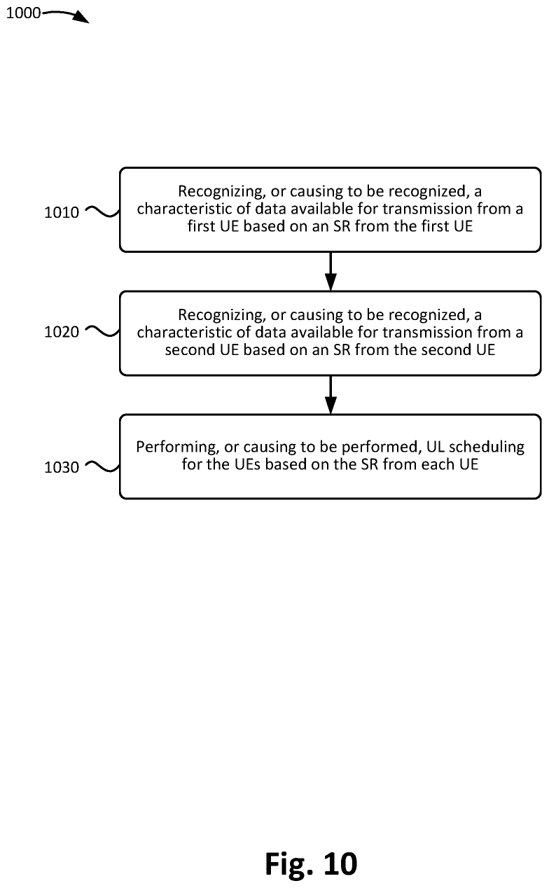

FIG. 10 is a flowchart diagram of an example process 1000 for UL scheduling based on different SRs from different UEs. Process 1000 may be performed by RAN node 111. As shown, process 1000 may include RAN node 111 recognizing, or causing to be recognized, a characteristic of data available for transmission from a first UE 101 based on an SR from the first UE 101 (block 1010). Additionally, process 1000 may include RAN node 111 recognizing, or causing to be recognized, a characteristic of data available for transmission from a second UE 101 based on an SR from the second UE 101 (block 1020). Process 1000 may further include performing, or causing to be performed, UL scheduling for the first and second UEs 101 (which may include providing UL grants to the UEs 101) based on the SR from each UE (block 1030).

As used herein, the term “circuitry,” “processing circuitry,” or “logic” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

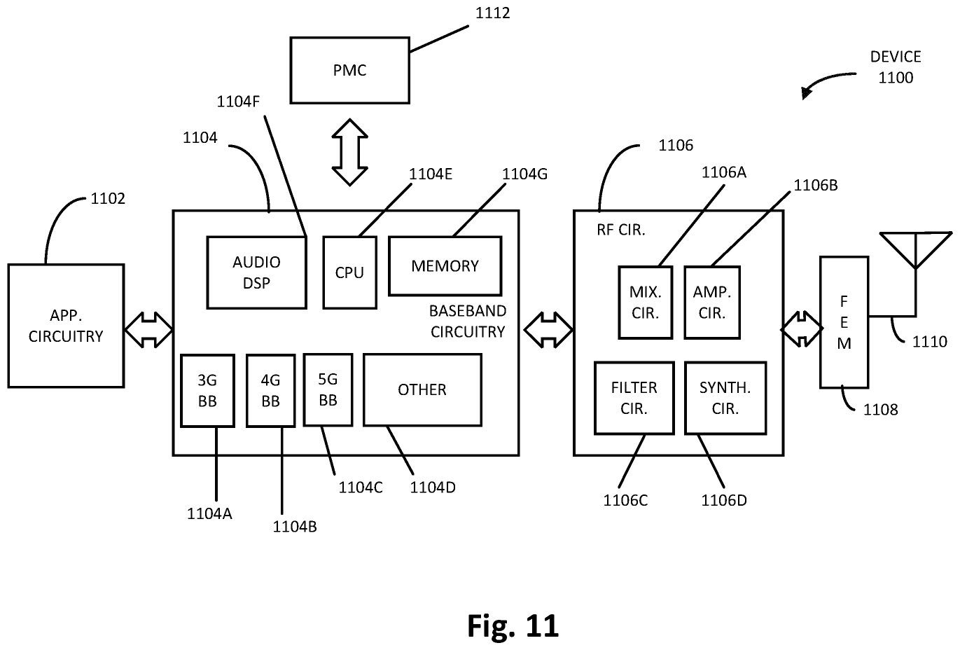

Embodiments described herein may be implemented into a system using any suitably configured hardware and/or software. FIG. 11 illustrates example components of a device 1100 in accordance with some embodiments. In some embodiments, the device 1100 may include application circuitry 1102, baseband circuitry 1104, Radio Frequency (RF) circuitry 1106, front-end module (FEM) circuitry 1108, one or more antennas 1110, and power management circuitry (PMC) 1112 coupled together at least as shown. The components of the illustrated device 1100 may be included in a UE or a RAN node. In some embodiments, the device 1100 may include less elements (e.g., a RAN node may not utilize application circuitry 1102, and instead include a processor/controller to process IP data received from an EPC). In some embodiments, the device 1100 may include additional elements such as, for example, memory/storage, display, camera, sensor, or input/output (I/O) interface In other embodiments, the components described below may be included in more than one device (e.g., said circuitries may be separately included in more than one device for Cloud-RAN (C-RAN) implementations).

The application circuitry 1102 may include one or more application processors. For example, the application circuitry 1102 may include circuitry such as, but not limited to, one. or more single-core or multi-core processors The processor(s) may include any combination of general-purpose processors and dedicated processors (e.g., graphics processors, application. (.processors, etc The processors may be coupled with or may include memory/storage and may be configured to execute instructions stored in the memory/storage to enable various applications or operating systems to run on the device 1100. In some embodiments, processors of application circuitry 1102 may process IP data packets received from an EPC.

The baseband circuitry 1104 may include circuitry such as, but not limited to, one or more single-core or multi-core processors. The baseband circuitry 1104 may include one or more baseband processors or control logic to process baseband signals received from a receive signal path of the RF circuitry 1106 and to generate baseband signals for a transmit signal path of the RF circuitry 1106. Baseband processing circuitry 1104 may interface with the application circuitry 1102 for generation and processing of the baseband signals and for controlling operations of the RF circuitry 1106. For example, in some embodiments, the baseband circuitry 1104 may include a third generation (3G) baseband processor 1104A, a fourth generation (4G) baseband processor 1104B, a fifth generation (5G) baseband processor 1104C, or other baseband processor(s) 1104D for other existing generations, generations in development or to be developed in the future (e.g., second generation (2G), sixth generation (6G), etc.). The baseband circuitry 1104 (e.g., one or more of baseband processors 1104A-D) may handle various radio control functions that enable communication with one or more radio networks via the RF circuitry 1106. In other embodiments, some or all of the functionality of baseband processors 1104A-D may be included in modules stored in the memory 1104G and executed via a Central Processing Unit (CPU) 1104E. The radio control functions may include, but are not limited to, signal modulation/demodulation, encoding/decoding, radio frequency shifting, etc. In some embodiments, modulation/demodulation circuitry of the baseband circuitry 1104 may include Fast-Fourier Transform (FFT), preceding, or constellation mapping/demapping functionality. In some embodiments, encoding/decoding circuitry of the baseband circuitry 1104 may include convolution, tail-biting convolution, turbo, Viterbi, or Low-Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1104 may include one or more audio digital signal processor(s) (DSP) 1104F. The audio DSP(s) 1104F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 1104 and the application circuitry 1102 may be implemented together such. as, for example, on a system on a chip (SOC)

In some embodiments, the baseband circuitry 1104 may provide for communication compatible with one or more radio technologies. For example, in some embodiments, the baseband circuitry 1104 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 1104 is configured to support radio communications of more than one wireless protocol may be referred to as multi-mode. baseband circuitry

RF circuitry 1106 may enable communication with wireless networks using modulated electromagnetic radiation through a non-solid medium. In various embodiments, the RF circuitry 1106 may include switches, filters, amplifiers, etc. to facilitate the communication. with the wireless network RF circuitry 1106 may include a receive signal path which may include circuitry to down-convert RF signals received from the FEM circuitry 1108 and provide baseband signals to the baseband circuitry 1104. RF circuitry 1106 may also include a transmit signal path which may include circuitry to up-convert baseband signals provided by the baseband circuitry 1104 and provide RF output signals to the FEM circuitry 1108 for transmission.

In some embodiments, the receive signal path of the RF circuitry 1106 may include mixer circuitry 1106a, amplifier circuitry 1106b and filter circuitry 1106c. In some embodiments, the transmit signal path of the RF circuitry 1106 may include filter circuitry 1106c and mixer circuitry 1106a. RF circuitry 1106 may also include synthesizer circuitry 1106d for synthesizing a frequency for use by the mixer circuitry 1106a of the receive signal path and the transmit signal path. In some embodiments, the mixer circuitry 1106a of the receive signal path may be configured to down-convert RF signals received from the FEM circuitry 1108 based on the synthesized frequency provided by synthesizer circuitry 1106d. The amplifier circuitry 1106b may be configured to amplify the down-converted signals and the filter circuitry 1106c may be a low-pass filter (LPF) or band-pass filter (BPF) configured to remove unwanted signals from the down-converted signals to generate output baseband signals. Output baseband signals may be provided to the baseband circuitry 1104 for further processing. In some embodiments, the output baseband signals may be zero-frequency baseband signals, although this is not a requirement. In some embodiments, mixer circuitry 1106a of the receive signal path may comprise passive mixers, although the scope of the embodiments is not limited in this respect.

In some embodiments, the mixer circuitry 1106a of the transmit signal path may be configured to up-convert input baseband signals based on the synthesized frequency provided by the synthesizer circuitry 1106d to generate RF output signals for the FEM circuitry 1108. The baseband signals may be provided by the baseband circuitry 1104 and may be filtered by filter circuitry 1106c.

In some embodiments, the mixer circuitry 1106a of the receive signal path and the mixer circuitry 1106a of the transmit signal path may include two or more mixers and may be arranged for quadrature downconversion and upconversion, respectively. In some embodiments, the mixer circuitry 1106a of the receive signal path and the mixer circuitry 1106a of the transmit signal path may include two or more mixers and may be arranged for image rejection (e.g., Hartley image rejection). In some embodiments, the mixer circuitry 1106a of the receive signal path and the mixer circuitry 1106a may be arranged for direct downconversion and direct upconversion, respectively. In some embodiments, the mixer circuitry 1106a of the receive signal path and the mixer circuitry 1106a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1106 may include analog-to-digital converter (ADC) and digital-to-analog converter (DAC) circuitry and the baseband circuitry 1104 may include a digital baseband interface to communicate with the RF circuitry 1106.

In some dual-mode embodiments, a separate radio IC circuitry may be provided for processing signals for each spectrum, although the scope of the embodiments is not limited in this respect.

In some embodiments, the synthesizer circuitry 1106d may be a fractional-N synthesizer or a fractional N/N+1 synthesizer, although the scope of the embodiments is not limited in this respect as other types of frequency synthesizers may be suitable. For example, synthesizer circuitry 1106d may be a delta-sigma synthesizer, a frequency multiplier, or a synthesizer comprising a phase-locked loop with a frequency divider.

The synthesizer circuitry 1106d may be configured to synthesize an output frequency for use by the mixer circuitry 1106a of the RF circuitry 1106 based on a frequency input and a divider control input. In some embodiments, the synthesizer circuitry 1106d may be a fractional N/N+1 synthesizer.

In some embodiments, frequency input may be provided by a voltage controlled oscillator (VCO), although that is not a requirement. Divider control input may be provided by either the baseband circuitry 1104 or the applications processor 1102 depending on the desired output frequency. In some embodiments, a divider control input (e.g., N) may be determined from a look-up table based on a channel indicated by the applications processor 1102.

Synthesizer circuitry 1106d of the RF circuitry 1106 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 1106d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 1106 may include an IQ/polar converter.

FEM circuitry 1108 may include a receive signal path which may include circuitry configured to operate on RF signals received from one or more antennas 1110, amplify the received signals and provide the amplified versions of the received signals to the RF circuitry 1106 for further processing. FEM circuitry 1108 may also include a transmit signal path which may include circuitry configured to amplify signals for transmission provided by the RF circuitry 1106 for transmission by one or more of the one or more antennas 1110. In various embodiments, the amplification through the transmit or receive signal paths may be done solely in the RF circuitry 1106, solely in the FEM 1108, or in both the RF circuitry 1106 and the FEM 1108.

In some embodiments, the FEM circuitry 1108 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 1106). The transmit signal path of the FEM circuitry 1108 may include a power amplifier (PA) to amplify input RF signals (e.g., provided by RF circuitry 1106), and one or more filters to generate RF signals for subsequent transmission (e.g., by one or more of the one or more antennas 1110).

In some embodiments, the PMC 1112 may manage power provided to the baseband circuitry 1104. In particular, the PMC 1112 may control power-source selection, voltage scaling, battery charging, or DC-to-DC conversion. The PMC 1112 may often be included when the device 1100 is capable of being powered by a battery, for example, when the device is included in a UE. The PMC 1112 may increase the power conversion efficiency while providing desirable implementation size and heat dissipation characteristics.

While FIG. 11 shows the PMC 1112 coupled only with the baseband circuitry 1104. However, in other embodiments, the PMC 1112 may be additionally or alternatively coupled with, and perform similar power management operations for, other components such as, but not limited to, application circuitry 1102, RF circuitry 1106, or FEM 1108.

In some embodiments, the PMC 1112 may control, or otherwise be part of, various power saving mechanisms of the device 1100. For example, if the device 1100 is in an RRC_Connected state, where it is still connected to the RAN node as it expects to receive traffic shortly, then it may enter a state known as Discontinuous Reception Mode (DRX) after a period of inactivity. During this state, the device 1100 may power down for brief intervals of time and thus save power.

If there is no data traffic activity for an extended period of time, then the device 1100 may transition off to an RRC_Idle state, where it disconnects from the network and does not perform operations such as channel quality feedback, handover, etc. The device 1100 goes into a very low power state and it performs paging where again it periodically wakes up to listen to the network and then powers down again. The device 1100 may not receive data in this state, in order to receive data, it must transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 1102 and processors of the baseband circuitry 1104 may be used to execute elements of one or more instances of a protocol stack. For example, processors of the baseband circuitry 1104, alone or in combination, may be used execute Layer 3, Layer 2, or Layer 1 functionality, while processors of the application circuitry 1104 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

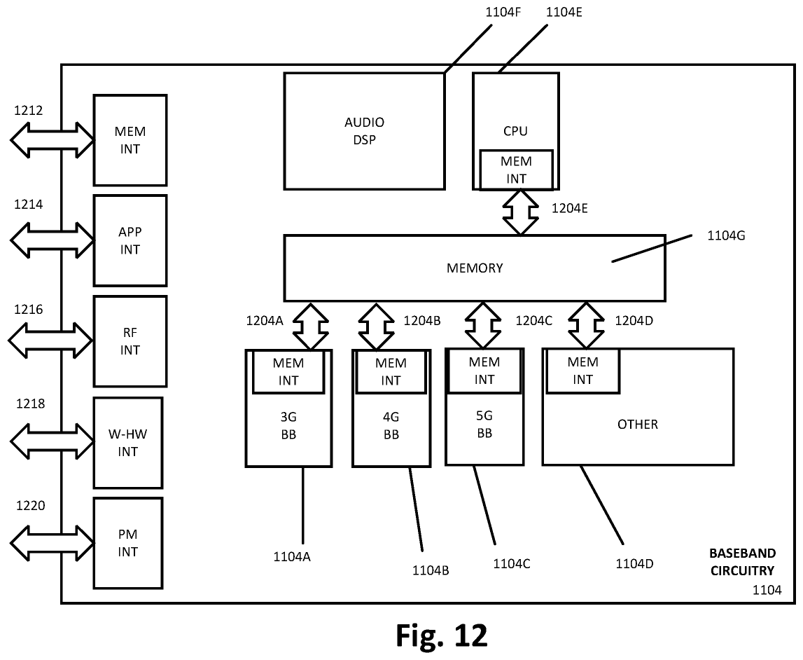

FIG. 12 illustrates example interfaces of baseband circuitry in accordance with some embodiments. As discussed above, the baseband circuitry 1104 of FIG. 11 may comprise processors 1104A-1104E and a memory 1104G utilized by said processors. Each of the processors 1104A-1104E may include a memory interface, respectively, to send/receive data to/from the memory 1204G.

The baseband circuitry 1104 may further include one or more interfaces to communicatively couple to other circuitries/devices, such as a memory interface 1212 (e.g., an interface to send/receive data to/from memory external to the baseband circuitry 1104), an application circuitry interface 1214 (e.g., an interface to send/receive data to/from the application circuitry 1102 of FIG. 11), an RF circuitry interface 1216 (e.g., an interface to send/receive data to/from RF circuitry 1106 of FIG. 11), a wireless hardware connectivity interface 818 (e.g., an interface to send/receive data to/from Near Field Communication (NFC) components, Bluetooth® components (e.g., Bluetooth® Low Energy), Wi-Fi® components, and other communication components), and a power management interface 1220 (e.g., an interface to send/receive power or control signals to/from the PMC 712).

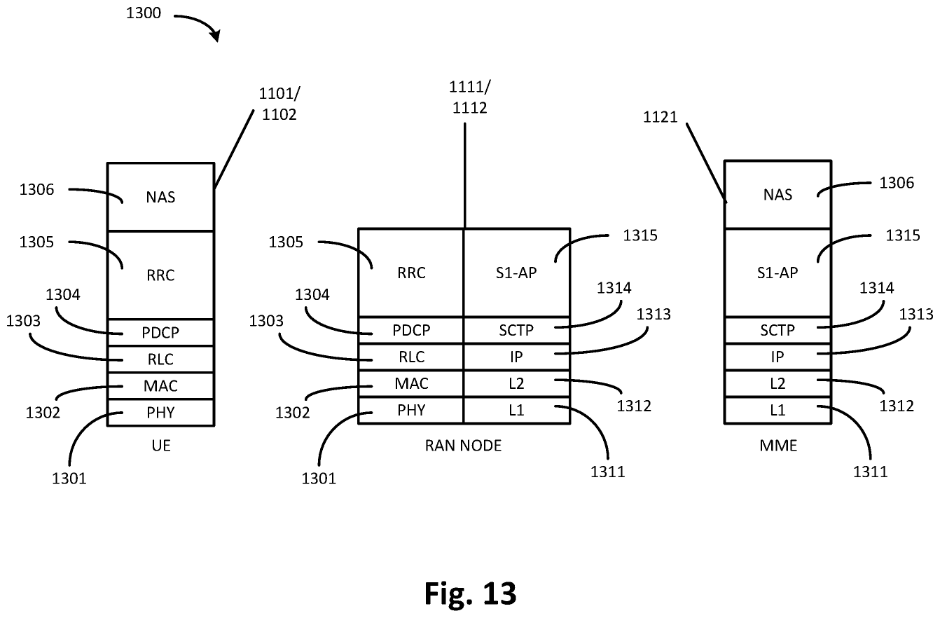

FIG. 13 is an illustration of a control plane protocol stack in accordance with some embodiments. In this embodiment, a control plane 1300 is shown as a communications protocol stack between the UE 101 (or alternatively, the UE 102), the RAN node 111 (or alternatively, the RAN node 112), and the MME 121.

The PHY layer 1301 may transmit or receive information used by the MAC layer 1302 over one or more air interfaces. The PHY layer 1301 may further perform link adaptation or adaptive modulation and coding (AMC), power control, cell search (e.g., for initial synchronization and handover purposes), and other measurements used by higher layers, such as the RRC layer 1305. The PHY layer 1301 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer 1302 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

The RLC layer 1303 may operate in a plurality of modes of operation, including: Transparent Mode (TM), Unacknowledged Mode (UM), and Acknowledged Mode (AM). The RLC layer 1303 may execute transfer of upper layer protocol data units (PDUs), error correction through automatic repeat request (ARQ) for AM data transfers, and concatenation, segmentation and reassembly of RLC SDUs for UM and AM data transfers. The RLC layer 1303 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer 1304 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer 1305 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection between the UE and E-UTRAN (e.g., RRC connection paging, RRC connection establishment, RRC connection modification, and RRC connection release), establishment, configuration, maintenance and release of point to point Radio Bearers, security functions including key management, inter radio access technology (RAT) mobility, and measurement configuration for UE measurement reporting. Said MIBs and SIBs may comprise one or more information elements (IEs), which may each comprise individual data fields or data structures.

The UE 101 and the RAN node 111 may utilize a Uu interface (e.g., an LTE-Uu interface) to exchange control plane data via a protocol stack comprising the PHY layer 1301, the MAC layer 1302, the RLC layer 1303, the PDCP layer 1304, and the RRC layer 1305. The non-access stratum (NAS) protocols 1306 form the highest stratum of the control plane between the UE 101 and the MME 121. The NAS protocols 1306 support the mobility of the UE 101 and the session management procedures to establish and maintain IP connectivity between the UE 101 and the P-GW 123.

The S1 Application Protocol (S1-AP) layer 1315 may support the functions of the S1 interface and comprise Elementary Procedures (EPs). An EP is a unit of interaction between the RAN node 111 and the CN 120. The S1-AP layer services may comprise two groups: UE-associated services and non UE-associated services. These services perform functions including, but not limited to: E-UTRAN Radio Access Bearer (E-RAB) management, UE capability indication, mobility, NAS signaling transport, RAN Information Management (RIM), and configuration transfer.

The Stream Control Transmission Protocol (SCTP) layer (alternatively referred to as the SCTP/IP layer) 1314 may ensure reliable delivery of signaling messages between the RAN node 111 and the MME 121 based, in part, on the IP protocol, supported by the IP layer 1313. The L2 layer 1312 and the L1 layer 1311 may refer to communication links (e.g., wired or wireless) used by the RAN node and the MME to exchange information.

The RAN node 111 and the MME 121 may utilize an S1-MME interface to exchange control plane data via a protocol stack comprising the L1 layer 1311, the L2 layer 1312, the IP layer 1313, the SCTP layer 1314, and the S1-AP layer 1315.

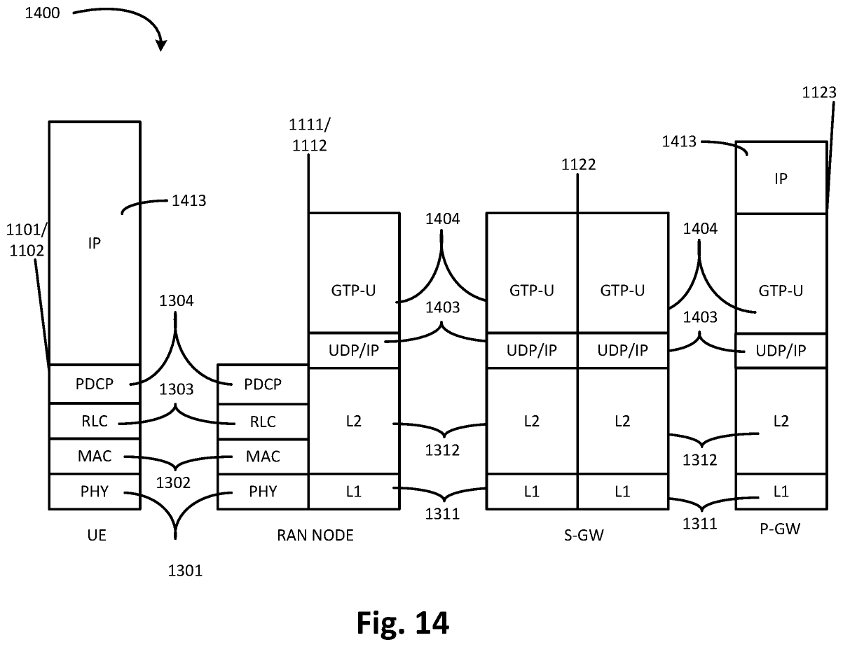

FIG. 14 is an illustration of a user plane protocol stack in accordance with some embodiments. In this embodiment, a user plane 1400 is shown as a communications protocol stack between the UE 101 (or alternatively, the UE 102), the RAN node 111 (or alternatively, the RAN node 112), the S-GW 122, and the P-GW 123. The user plane 1400 may utilize at least some of the same protocol layers as the control plane 1300. For example, the UE 101 and the RAN node 111 may utilize a Uu interface (e.g., an LTE-Uu interface) to exchange user plane data via a protocol stack comprising the PHY layer 1301, the MAC layer 1302, the RLC layer 1303, the PDCP layer 1304.

The General Packet Radio Service (GPRS) Tunneling Protocol for the user plane (GTP-U) layer 1404 may be used for carrying user data within the GPRS core network and between the radio access network and the core network. The user data transported can be packets in any of IPv4, IPv6, or PPP formats, for example. The UDP and IP security (UDP/IP) layer 1403 may provide checksums for data integrity, port numbers for addressing different functions at the source and destination, and encryption and authentication on the selected data flows. The RAN node 111 and the S-GW 122 may utilize an S1-U interface to exchange user plane data via a protocol stack comprising the L1 layer 1311, the L2 layer 1312, the UDP/IP layer 1403, and the GTP-U layer 1404. The S-GW 122 and the P-GW 123 may utilize an S5/S8a interface to exchange user plane data via a protocol stack comprising the L1 layer 1311, the L2 layer 1312, the UDP/IP layer 1403, and the GTP-U layer 1404. As discussed above with respect to FIG. 13, NAS protocols support the mobility of the UE 101 and the session management procedures to establish and maintain IP connectivity between the UE 101 and the P-GW 123.

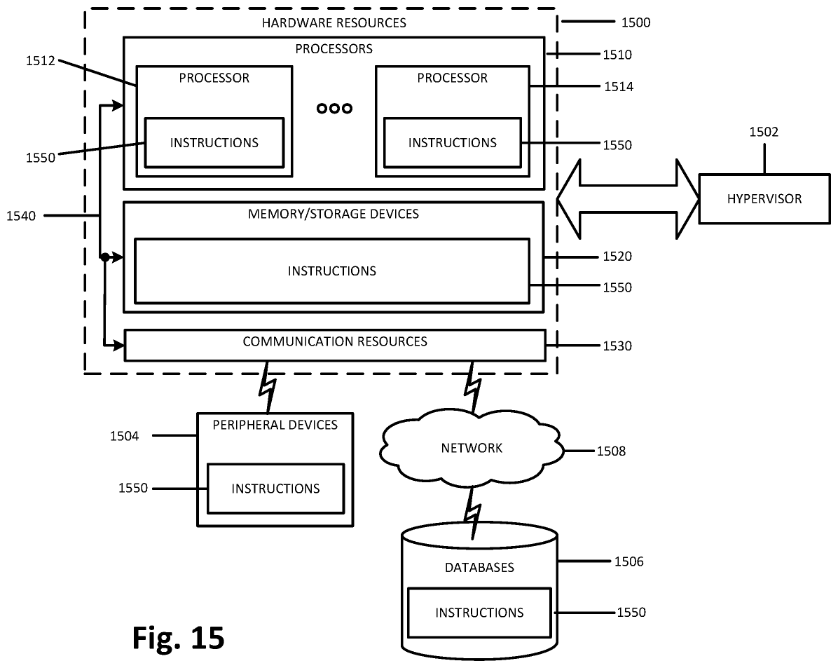

FIG. 15 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 15 shows a diagrammatic representation of hardware resources 1500 including one or more processors (or processor cores) 1510, one or more memory/storage devices 1520, and one or more communication resources 1530, each of which may be communicatively coupled via a bus 1540. For embodiments where node virtualization (e.g., NFV) is utilized, a hypervisor 1502 may be executed to provide an execution environment for one or more network slices/sub-slices to utilize the hardware resources 1500

The processors 1510 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1512 and a processor 1514.

The memory/storage devices 1520 may include main memory, disk storage, or any suitable combination thereof. The memory/storage devices 1520 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

The communication resources 1530 may include interconnection or network interface components or other suitable devices to communicate with one or more peripheral devices 1504 or one or more databases 1506 via a network 1508. For example, the communication resources 1530 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1550 may comprise software, a program, an application, an applet, an app, or other executable code for causing at least any of the processors 1510 to perform any one or more of the methodologies discussed herein. The instructions 1550 may reside, completely or partially, within at least one of the processors 1510 (e.g., within the processor's cache memory), the memory/storage devices 1520, or any suitable combination thereof. Furthermore, any portion of the instructions 1550 may be transferred to the hardware resources 1500 from any combination of the peripheral devices 1504 or the databases 1506. Accordingly, the memory of processors 1510, the memory/storage devices 1520, the peripheral devices 1504, and the databases 1506 are examples of computer-readable and machine-readable media.

A number of examples, relating to embodiments of the techniques described above, will next be given.

In a first example, an apparatus of a User Equipment (UE) may comprise: an interface to radio frequency (RF) circuitry; and one or more processors to: map a logical channel to a Scheduling Request (SR) configuration, the SR configuration including Physical Uplink Control Channel (PUCCH) resources for transmitting a SR to a Radio Access Network (RAN) node and the SR including a request for Uplink Shared Channel (UL-SCH) resources for using the logical channel to transmit data to the RAN node; an cause the SR to be transmitted, to the RAN node via the interface to the RF circuitry, using the PUCCH resources of the SR configuration.

In example 2, the subject matter of example 1, or any of the examples herein, wherein the logical channel is mapped to the SR configuration based on a priority, a numerology, and Transmission Time Interval (TTI) associated with the logical channel.

In example 3, the subject matter of example 1, or any of the examples herein, wherein the SR configuration includes a periodicity for transmitting the SR to the RAN node.

In example 4, the subject matter of example 1, or any of the examples herein, wherein the one or more processors are further to: receive, in response to the SR, a (Uplink) UL grant for using the logical channel to communicate the data to RAN node, and cause the data to be communicated to the RAN in accordance with the UL grant, the UL grant being consistent with a priority, sub-carrier spacing (SCS) and Physical Uplink Shared Channel (PUSCH) transmission duration of the logical channel.

In example 5, the subject matter of example 1, or any of the examples herein, wherein the one or more processors is to map the logical channel to the SR configuration based on a logical channel group corresponding to the logical channel.

In example 6, the subject matter of example 1, or any of the examples herein, wherein the SR configuration includes one SR configuration, of a plurality of SR configurations, each SR configuration, of the plurality of SR configurations being associated with one or more logical channels.

In example 7, the subject matter of example 1, or any of the examples herein, wherein the one or more processors are further to: prior to mapping the logical channel to the SR configuration, process Radio Resource Control (RRC) signaling, from the RAN node, including information associating the logical channel to the SR configuration.

In example 8, the subject matter of example 1, or any of the examples herein, wherein the one or more processors are further to: process Radio Resource Control (RRC) signaling, from the RAN node, including information associating the logical channel to a different SR configuration.

In a ninth example, an apparatus of a User Equipment (UE) may comprise: an interface to radio frequency (RF) circuitry; and one or more processors to: map a logical channel, for transmitting data to a Radio Access Network (RAN) node, to a Scheduling Request (SR) configuration, of a plurality of SR configurations, for communicating a SR to the RAN node regarding the logical channel, each SR configuration, of the plurality of SR configurations, including distinct physical channel resources for communicating SRs to RAN nodes; and cause the SR to be communicated, to the RAN node via the interface to the RF circuitry, in accordance with the SR configuration to obtain an uplink (UL) grant for transmitting the data to the RAN node via the logical channel.

In example 10, the subject matter of example 9, or any of the examples herein, wherein the logical channel is mapped to the SR configuration based on a priority, a numerology, and Transmission Time Interval (TTI) associated with the logical channel.

In example 11, the subject matter of example 9, or any of the examples herein, wherein the SR configuration includes a periodicity for transmitting the SR to the RAN node.

In example 12, the subject matter of example 9, or any of the examples herein, wherein the one or more processors are further to: receive, in response to the SR, the UL grant for using the logical channel to communicate the data to the RAN node, and cause the data to be communicated to the RAN in accordance with the UL grant, the UL grant being consistent with a priority, sub-carrier spacing (SCS) and Physical Uplink Shared Channel (PUSCH) transmission duration of the logical channel.

In example 13, the subject matter of example 9, or any of the examples herein, wherein the one or more processors is to map the logical channel to the SR configuration based on a logical channel group corresponding to the logical channel.

In example 14, the subject matter of example 9, or any of the examples herein, wherein the plurality of SR configurations includes eight distinct SR configurations.

In example 15, the subject matter of example 9, or any of the examples herein, wherein the one or more processors are further to: prior to mapping the logical channel to the SR configuration, process Radio Resource Control (RRC) signaling, from the RAN node, including information associating the logical channel to the SR configuration.

In example 16, the subject matter of example 9, or any of the examples herein, wherein the one or more processors are further to: receive, via the interface to the RF circuitry and from the RAN node, a Radio Resource Control (RRC) message including information associating the logical channel to a different SR configuration, of the plurality of SR configurations.

In a seventeenth example, a computer-readable medium containing program instructions for causing one or more processors, associated with a User Equipment (UE), to: map a logical channel to a Scheduling Request (SR) configuration, the SR configuration including Physical Uplink Control Channel (PUCCH) resources for transmitting a SR to a Radio Access Network (RAN) node and the SR including a request for Uplink Shared Channel (UL-SCH) resources for using the logical channel to transmit data to the RAN node; and cause the SR to be transmitted, to the RAN node via the interface to the RF circuitry, using the PUCCH resources of the SR configuration.

In an eighteenth example, an apparatus of a User Equipment (UE), the apparatus comprising: means for mapping a logical channel to a Scheduling Request (SR) configuration, the SR configuration including Physical Uplink Control Channel (PUCCH) resources for transmitting a SR to a Radio Access Network (RAN) node and the SR including a request for Uplink Shared Channel (UL-SCH) resources for using the logical channel to transmit data to the RAN node; and means for causing the SR to be transmitted, to the RAN node via the interface to the RF circuitry, using the PUCCH resources of the SR configuration.

In a nineteenth example, a method, performed by a User Equipment (UE), the method comprising: mapping a logical channel to a Scheduling Request (SR) configuration, the SR configuration including Physical Uplink Control Channel (PUCCH) resources for transmitting a SR to a Radio Access Network (RAN) node and the SR including a request for Uplink Shared Channel (UL-SCH) resources for using the logical channel to transmit data to the RAN node; and causing the SR to be transmitted, to the RAN node via the interface to the RF circuitry, using the PUCCH resources of the SR configuration.

In the preceding specification, various embodiments have been described with reference to the accompanying drawings. It will, however, be evident that various modifications and changes may be made thereto, and additional embodiments may be implemented, without departing from the broader scope as set forth in the claims that follow. The specification and drawings are accordingly to be regarded in an illustrative rather than restrictive sense.

For example, while series of signals and/or operations have been described with regard to FIGS. 2, 4, 5, 9, and 10, the order of the signals/operations may be modified in other implementations. Further, non-dependent signals may be performed in parallel.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Even though particular combinations of features are recited in the claims and/or disclosed in the specification, these combinations are not intended to be limiting. In fact, many of these features may be combined in ways not specifically recited in the claims and/or disclosed in the specification.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used.

1-24. (canceled)

25. An apparatus of a User Equipment (UE), the apparatus comprising:
an interface to radio frequency (RF) circuitry; and
one or more processors to:
map a logical channel to a Scheduling Request (SR) configuration, the SR configuration including Physical Uplink Control Channel (PUCCH) resources for transmitting a SR to a Radio Access Network (RAN) node and the SR including a request for Uplink Shared Channel (UL-SCH) resources for using the logical channel to transmit data to the RAN node; and
cause the SR to be transmitted, to the RAN node via the interface to the RF circuitry, using the PUCCH resources of the SR configuration.

26. The apparatus of claim 25, wherein the logical channel is mapped to the SR configuration based on a priority, a numerology, and Transmission Time Interval (TTI) associated with the logical channel.

27. The apparatus of claim 25, wherein the SR configuration includes a periodicity for transmitting the SR to the RAN node.

28. The apparatus of claim 25, wherein the one or more processors are further to: receive, in response to the SR, a (Uplink) UL grant for using the logical channel to communicate the data to RAN node, and cause the data to be communicated to the RAN in accordance with the UL grant, the UL grant being consistent with a priority, sub-carrier spacing (SCS) and Physical Uplink Shared Channel (PUSCH) transmission duration of the logical channel.

29. The apparatus of claim 25, wherein the one or more processors is to map the logical channel to the SR configuration based on a logical channel group corresponding to the logical channel.

30. The apparatus of claim 25, wherein the SR configuration includes one SR configuration, of a plurality of SR configurations, each SR configuration, of the plurality of SR configurations being associated with one or more logical channels.

31. The apparatus of claim 25, wherein the one or more processors are further to: prior to mapping the logical channel to the SR configuration, process Radio Resource Control (RRC) signaling, from the RAN node, including information associating the logical channel to the SR configuration.

32. The apparatus of claim 25, wherein the one or more processors are further to: process Radio Resource Control (RRC) signaling, from the RAN node, including information associating the logical channel to a different SR configuration.

33. An apparatus of a User Equipment (UE), the apparatus comprising:
an interface to radio frequency (RF) circuitry; and
one or more processors to:
map a logical channel, for transmitting data to a Radio Access Network (RAN) node, to a Scheduling Request (SR) configuration, of a plurality of SR configurations, for communicating a SR to the RAN node regarding the logical channel, each SR configuration, of the plurality of SR configurations, including distinct physical channel resources for communicating SRs to RAN nodes; and
cause the SR to be communicated, to the RAN node via the interface to the RF circuitry, in accordance with the SR configuration to obtain an uplink (UL) grant for transmitting the data to the RAN node via the logical channel.

34. The apparatus of claim 33, wherein the logical channel is mapped to the SR configuration based on a priority, a numerology, and Transmission Time Interval (TTI) associated with the logical channel.

35. The apparatus of claim 33, wherein the SR configuration includes a periodicity for transmitting the SR to the RAN node.

36. The apparatus of claim 33, wherein the one or more processors are further to: receive, in response to the SR, the UL grant for using the logical channel to communicate the data to the RAN node, and cause the data to be communicated to the RAN in accordance with the UL grant, the UL grant being consistent with a priority, sub-carrier spacing (SCS) and Physical Uplink Shared Channel (PUSCH) transmission duration of the logical channel.

37. The apparatus of claim 33, wherein the one or more processors is to map the logical channel to the SR configuration based on a logical channel group corresponding to the logical channel.

38. The apparatus of claim 33, wherein the plurality of SR configurations includes eight distinct SR configurations.

39. The apparatus of claim 33, wherein the one or more processors are further to: prior to mapping the logical channel to the SR configuration, process Radio Resource Control (RRC) signaling, from the RAN node, including information associating the logical channel to the SR configuration.

40. The apparatus of claim 33, wherein the one or more processors are further to: receive, via the interface to the RF circuitry and from the RAN node, a Radio Resource Control (RRC) message including information associating the logical channel to a different SR configuration, of the plurality of SR configurations.

41. A non-transitory computer-readable medium containing program instructions for causing one or more processors, associated with a User Equipment (UE), to:
map a logical channel to a Scheduling Request (SR) configuration, the SR configuration including Physical Uplink Control Channel (PUCCH) resources for transmitting a SR to a Radio Access Network (RAN) node and the SR including a request for Uplink Shared Channel (UL-SCH) resources for using the logical channel to transmit data to the RAN node; and
cause the SR to be transmitted, to the RAN node via the interface to the RF circuitry, using the PUCCH resources of the SR configuration.

42. The non-transitory computer-readable medium of claim 41, wherein the logical channel is mapped to the SR configuration based on a priority, a numerology, and Transmission Time Interval (TTI) associated with the logical channel.

43. The non-transitory computer-readable medium of claim 41, wherein the SR configuration includes a periodicity for transmitting the SR to the RAN node.

44. The non-transitory computer-readable medium of claim 41, wherein the one or more processors are further to: receive, in response to the SR, a (Uplink) UL grant for using the logical channel to communicate the data to RAN node, and cause the data to be communicated to the RAN in accordance with the UL grant, the UL grant being consistent with a priority, sub-carrier spacing (SCS) and Physical Uplink Shared Channel (PUSCH) transmission duration of the logical channel.

45. The non-transitory computer-readable medium of claim 41, wherein the one or more processors is to map the logical channel to the SR configuration based on a logical channel group corresponding to the logical channel.

46. The non-transitory computer-readable medium of claim 41, wherein the SR configuration includes one SR configuration, of a plurality of SR configurations, each SR configuration, of the plurality of SR configurations being associated with one or more logical channels.

47. The non-transitory computer-readable medium of claim 41, wherein the one or more processors are further to: prior to mapping the logical channel to the SR configuration, process Radio Resource Control (RRC) signaling, from the RAN node, including information associating the logical channel to the SR configuration.

48. The non-transitory computer-readable medium of claim 41, wherein the one or more processors are further to: process Radio Resource Control (RRC) signaling, from the RAN node, including information associating the logical channel to a different SR configuration.
